(19) United States
(12) Patent Application Publication
(10) Pub. No.: US 2026/0044255 A1
(43) Pub. Date: Feb. 12, 2026

(54) GOLF SYSTEM WITH CUSTOMIZABLE GRAPHICAL USER INTERFACE

(71) Applicant: Textron Inc., Providence, RI (US)

(72) Inventors: Christopher Alexander Boehm, North Augusta, SC (US); Cassidy Feng Khounborine, Augusta, GA (US)

(73) Assignee: Textron Inc., Providence, RI (US)

(21) Appl. No.: 18/798,442

(22) Filed: Aug. 8, 2024

(51) Int. Cl. G06F 3/04847; A63B 57/00; A63B 71/06; G06F 3/0482; G06F 9/451

(52) U.S. Cl. CPC G06F 3/04847; A63B 57/505; A63B 71/0622; G06F 3/0482; G06F 9/451; A63B 71/0669; A63B 2071/0691; A63B 2220/14

(57) ABSTRACT

A golf system includes a golf vehicle including a display device and a first communications interface and a server including a second communications interface to facilitate communications with the first communications interface and a user device and a processing circuit to provide a first graphical user interface on the user device, the first graphical user interface including a widget customizer that facilitates selecting widgets of a second graphical user interface for display on the display device, receive inputs from the user device to select the widgets of the second graphical user interface, the inputs including a first selection of a size of the widgets and a second selection of a function of the widgets, and transmit data corresponding to the second graphical user interface to the first communications interface of the golf vehicle. The display device is configured to display the second graphical user interface in accordance with the data.

### BACKGROUND

Golf carts include displays to display information to a user relating to the golf course and operation of the golf cart. Such displays may display information that impedes a view of the information relating to the golf course such that the user is unable to view information relating to the current hole they are playing. Such displays may include a plurality of menus through which the user must navigate to display desired information.

### SUMMARY

One embodiment relates to a golf system for customizing a graphical user interface. The golf system includes a golf vehicle including a display device and a first communications interface and a server including a second communications interface configured to facilitate communications with the first communications interface and a user device and one or more processing circuits configured to provide a first graphical user interface on the user device, the first graphical user interface including a widget customizer that facilitates selecting one or more widgets of a second graphical user interface for display on the display device, receive inputs from the user device through the widget customizer to select the one or more widgets of the second graphical user interface, the inputs including a first selection of a size of the one or more widgets and a second selection of a function of the one or more widgets, and transmit data corresponding to the second graphical user interface to the first communications interface of the golf vehicle. The display device is configured to display the second graphical user interface in accordance with the data.

Another embodiment relates to a golf system for customizing a graphical user interface. The golf system includes one or more processing circuits comprising one or more memory devices coupled to one or more processors, the one or more memory devices configured to store instructions thereon that, when executed by the one or more processors, cause the one or more processors to provide a first graphical user interface on a user device, the first graphical user interface including a widget customizer that facilitates selecting one or more widgets of a second graphical user interface for display on a display device, receive inputs from the user device through the widget customizer to select the one or more widgets of the second graphical user interface, the inputs including a first selection of a size of the one or more widgets and a second selection of a function of the one or more widgets, and transmit data corresponding to the second graphical user interface to a communications interface of a golf vehicle. The display device is configured to display the second graphical user interface in accordance with the data.

Still another embodiment relates to a golf system for customizing a graphical user interface. The golf system includes a non-transitory computer-readable medium having instructions stored thereon that, when executed by one or more processors, cause the one or more processors to provide a first graphical user interface on a user device, the first graphical user interface including a widget customizer that facilitates selecting one or more widgets of a second graphical user interface for display on a display device, receive inputs from the user device through the widget customizer to select the one or more widgets of the second graphical user interface, the inputs including a first selection of a size of the one or more widgets and a second selection of a function of the one or more widgets, and transmit data corresponding to the second graphical user interface to a communications interface of a golf vehicle. The display device is configured to display the second graphical user interface in accordance with the data.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a graphical user interface (“GUI”) displaying a home screen, according to an exemplary embodiment.

FIG. 5 is a GUI displaying the home screen of FIG. 4 including a menu panel with menu buttons expanded, according to an exemplary embodiment.

FIG. 6 is a GUI displaying a menu screen including menu buttons, according to an exemplary embodiment.

FIG. 7 is a GUI displaying a hole view including a full-sized widget and a quarter-sized widget, according to an exemplary embodiment.

FIG. 8 is a GUI displaying a hole view including two quarter-sized widgets and a half-sized widget, according to an exemplary embodiment.

FIG. 9 is a GUI displaying a hole view including four quarter-sized widgets, according to an exemplary embodiment.

FIG. 10 is a GUI displaying a hole view including a full-sized widget, according to an exemplary embodiment.

FIG. 11 is a GUI displaying a hole view including two half-sized widgets, according to an exemplary embodiment.

FIG. 12 is a GUI displaying a hole view including a half-sized widget and two quarter-sized widgets, according to an exemplary embodiment.

FIG. 13 is a GUI displaying a widget customizer screen, according to an exemplary embodiment.

FIG. 14 is a GUI displaying the widget customizer screen of FIG. 13 with a widget size selector tool overlaid thereon, according to an exemplary embodiment.

FIG. 15 is a GUI displaying a widget customizer screen of FIG. 13 including a widget function selector tool overlaid thereon, according to an exemplary embodiment.

FIG. 16A-16F are full-sized widgets, according to various exemplary embodiments.

FIG. 17A-17U are half-sized widgets, according to various exemplary embodiments.

FIG. 18A-18I are quarter-sized widgets, according to various exemplary embodiments.

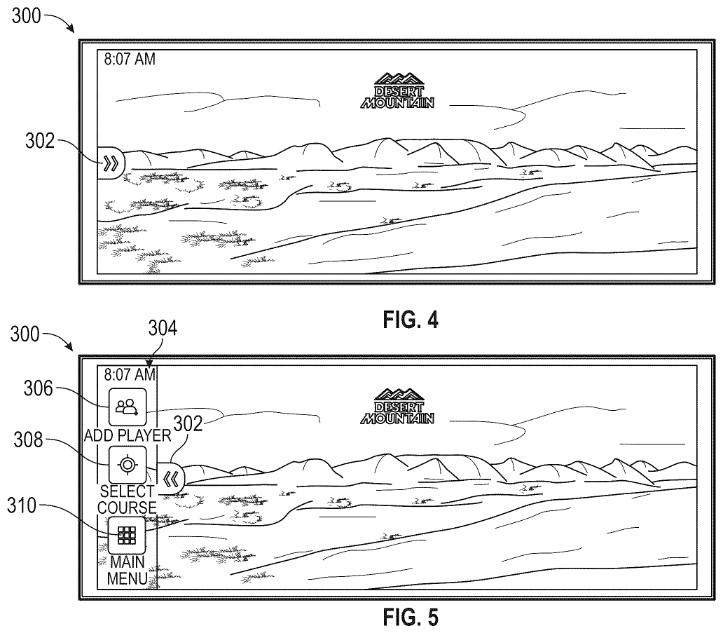

The Appendix being submitted herewith includes color images relating to FIG. 4-18I. The Appendix being submitted herewith is incorporated herein by reference in its entirety. The color images of the Appendix may be used as the basis for any amendment to this Application or in a continuation application or a design application claiming priority hereto.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, the vehicle of the present disclosure includes an operator interface including one or more displays that may be or include a touchscreen, a LCD display, a LED display, etc. The operator interface is configured to display one or more GUIs to provide a user of the vehicle (e.g., a golfer, an operator, etc.) information relating to a golf course on which the vehicle is operating, information relating to operation of the vehicle, and/or any other information (e.g., date and time, advertisements, a music player, etc.). According to an exemplary embodiment, the GUI includes an element to display a respective hole the vehicle is on and one or more widgets to display the information discussed above. The one or more widgets are positioned to not obstruct the element including the respective hole the vehicle is on.

The GUI includes a widget customizer to facilitate selecting (e.g., customizing) the size and the function of the widgets to be displayed. The size may include a quarter-size widget, a half-size widget, and a full-size widget, among other possible sized (e.g., a one-third size widget). The function may include a topographical map corresponding to a green of a respective hole the vehicle is on, an advertisement, a first distance indicator corresponding to a first distance for the respective hole, a second distance indicator corresponding to a second distance from a location of the vehicle to a pin for the respective hole, a date and time indicator, a music player, an image customizable by the user, etc. The widget customizer may be displayed on a user device configured to receive inputs to the widget customizer to facilitate customizing the GUI to display widgets desired by the user.

### Overall Vehicle

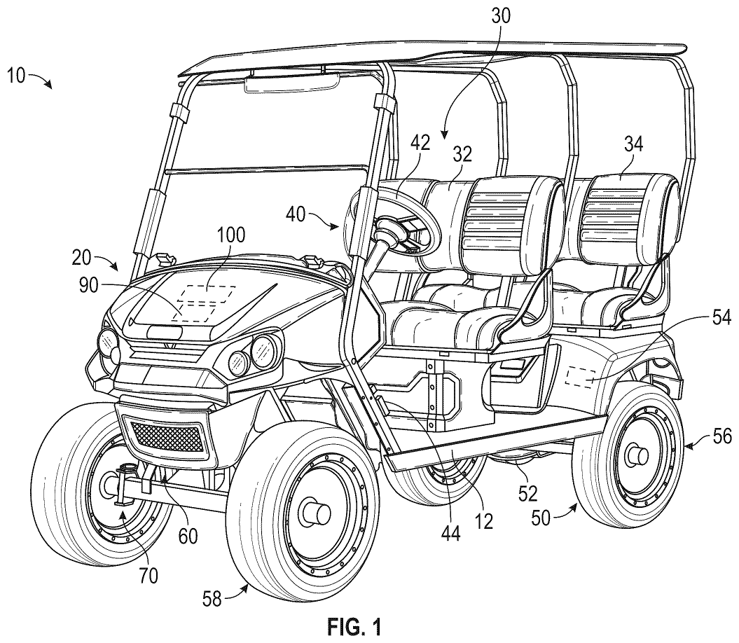

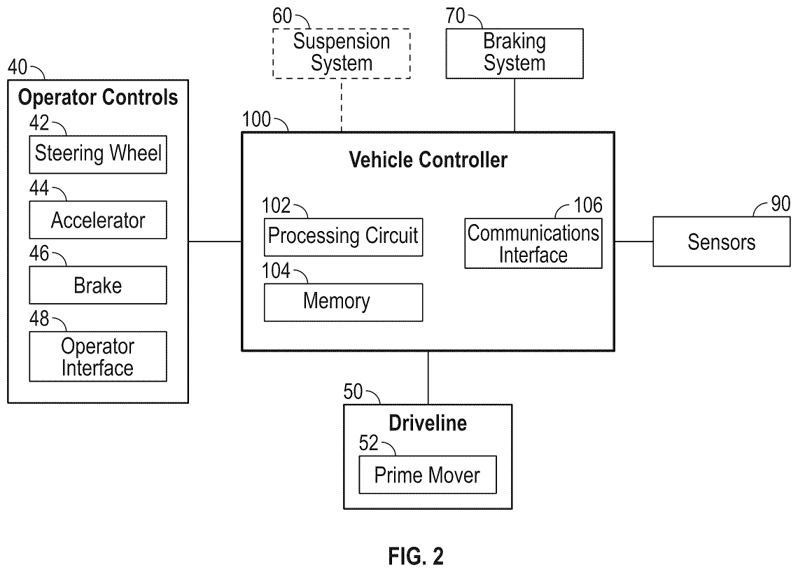

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system.

In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein.

According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.).

According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

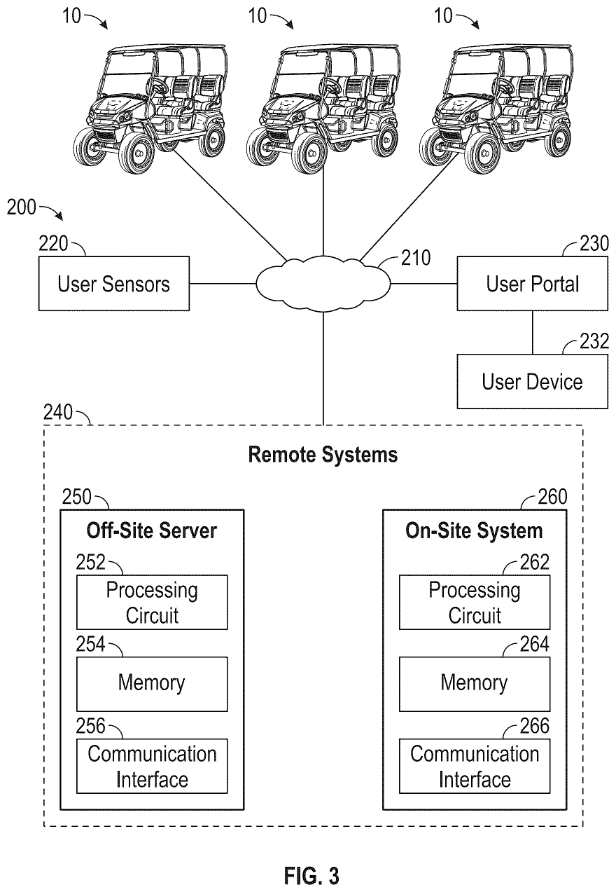

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Graphical User Interface Customization

As shown in FIGS. 4 and 5, a first user interface, shown as home screen GUI 300, is configured to provide one or more views such as a home screen view or home screen view with a menu bar. The home screen GUI 300 can be provided to the operator interface 48 and/or the user device 232 for display on the one or more displays thereof, respectively.

As shown in FIG. 4, the home screen GUI 300 displays the home screen view (e.g., a screen saver) including a first element, shown as menu button 302. A user may interact with (e.g., engage, provide an input to, etc.) the menu button 302 to cause the home screen GUI 300 to display one or more additional elements or menus. By way of example, after interacting with the menu button 302, the home screen GUI 300 may display a menu panel (e.g., menu panel 304). In some embodiments, the home screen GUI 300 includes a different backgrounds (e.g., customizable backgrounds) and provides added functionality such as home screen widgets, additional setting buttons, information relating to golf course data (e.g., the current time, outside temperature, hole yardage, pin positioning, hole number, pace of play, scorecards, etc.), etc.

As shown in FIG. 5, the home screen GUI 300 displays an element panel, shown as menu panel 304. By way of example, after the menu button 302 has been interacted with, the home screen GUI 300 displays the menu panel 304. The menu panel 304 takes up (e.g., covers) a portion of the home screen. When the menu panel 304 is displayed, the user may interact with the menu button 302 to hide the menu panel 304. The menu panel 304 includes a first menu element, shown as add player button 306, a second menu element, shown as select course button 308, and a third menu element, shown as main menu button 310. In some embodiments, the menu panel 304 includes one or more additional or different buttons (e.g., scorecard button, language button, setup button, weather button, music button, etc.).

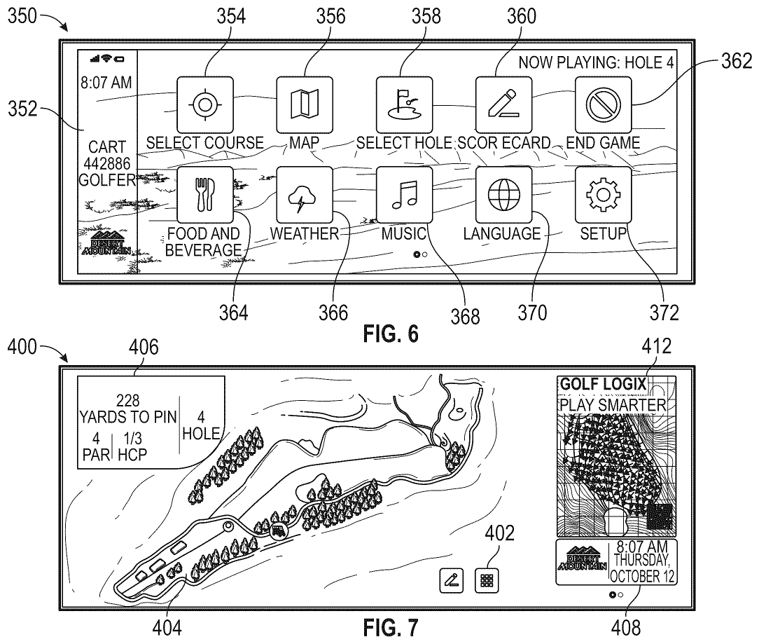

As shown in FIG. 6, a second user interface, shown as main menu GUI 350, is configured to display a plurality of buttons or widgets to facilitate accessing information relating to a golf course on which the vehicle 10 is operating e.g., hole yardage, pin positioning, hole number, pace of play, scorecards, etc.), information relating to operation of the vehicle 10 (e.g., GPS data, RTK data, vehicle speed, fuel level, warnings, messages, etc.), and/or any other information (e.g., advertisements, a music player, settings, etc.). The main menu GUI 350 can be provided to the operator interface 48 and/or the user device 232 for display on the one or more displays thereof, respectively.

As shown in FIG. 6, the main menu GUI 350 displays a main menu view. In the main menu view, the main menu GUI 350 includes a plurality of widgets, elements, or buttons including a first element, shown as select course button 354, a second element, shown as map button 356, a third element, shown as select hole button 358, a fourth element, shown as scorecard button 360, an fifth element, shown as end game button 362, a sixth element, shown as food and beverage button 364, a seventh element, shown as weather button 366, an eight element, shown as music button 368, a ninth element, shown as language button 370, and a tenth element, shown as setup button 372. In response to the user providing an input to the select course button 354, the main menu GUI 350 may transition to another interface for the user to select which course they are playing at (e.g., which golf course the vehicle 10 is located at). In response to the user providing an input to the map button 356, the main menu GUI 350 may transition to another interface including a map of the golf course or the hole. In response to the user providing an input to the select hole button 358, the main menu GUI 350 may transition to another interface for the user to select and view a particular hole of the golf course. In response to the user providing an input to the scorecard button 360, the main menu GUI 350 may transition to another interface including a scorecard of the user and/or group associated with the user. In response to the user providing an input to the end game button 362, the main menu GUI 350 may transition to another display including information relating to the round the golfer played. In response to the user providing an input to the food and beverage button 364, the main menu GUI 350 may transition to another interface that provides a menu and/or an interface for the user to order food (e.g., from the clubhouse, a local restaurant, from the halfway house, from a drink cart, etc.). In response to the user providing an input to the weather button 366, the main menu GUI 350 may transition to another interface displaying information relating to the current and/or future weather. In response to the user providing an input to the music button 368, the main menu GUI 350 may transition to another interface with a music player (e.g., including the audio being played, a rewind button, a skip button, a pause/play button, etc.). In response to the user providing an input to the language button 370, the main menu GUI 350 may transition to another interface for the user to select a desired language for the GUIs described herein. In response to the user providing an input to the setup button 372, the main menu GUI 350 may transition to another interface with a settings menu for the user to configure vehicle 10 and/or the GUIs described herein.

In some embodiments, the main menu GUI 350 includes fewer, additional, or different buttons. In some embodiments, the main menu GUI 350 is configurable by the user (e.g., by an owner of the golf course or the vehicle 10) and updated across a fleet of the vehicles 10 according to the offerings of the golf course. By way of example, if the golf course does not offer food and beverage, the food and beverage button 364 may be removed or otherwise inaccessible to a golfer. As shown in FIG. 6, the main menu GUI 350 includes an information panel, shown as info bar 352, configured to provide information to the user (i.e., the golfer) such as an identification of the vehicle 10 (e.g., a cart number), the date and time, a golfer identification (e.g., name), etc. In some embodiments, the main menu GUI 350 does not include the info bar 352. In some embodiments, the buttons may be displayed by the GUI 350 in one or more pages such that a first page includes a first subset of buttons, a second page includes a second subset of buttons, etc. As shown in FIG. 6, the GUI 350 includes two pages indicated by the two circles (e.g., indicators) along a bottom edge of the GUI 350. In some embodiments, the GUI 350 includes more or fewer than two pages (e.g., one, three, four, etc. panes). By way of example, the user may configure the GUI 350 to include a desired number of pages with each page having a desired number of buttons. In embodiments where the GUI 350 includes two or more pages, the user can navigate through the pages by swiping (e.g., for touch-screen compatible devices), selecting the circle corresponding to a desired page, using voice commands, using hard keys, buttons, knobs, selectors, etc. of the operator interface 48, etc. The selected circle may provide an indication (e.g., may be highlighted) indicative of selected page being displayed.

As shown in FIG. 7-12, a third user interface, shown as hole GUI 400, is configured to display information relating to a golf course and a hole of the golf course on which the vehicle 10 is operating, information relating to operation of the vehicle 10, and/or any other information. The hole GUI 400 can be provided to the operator interface 48 and/or the user device 232 for display on the one or more displays thereof, respectively.

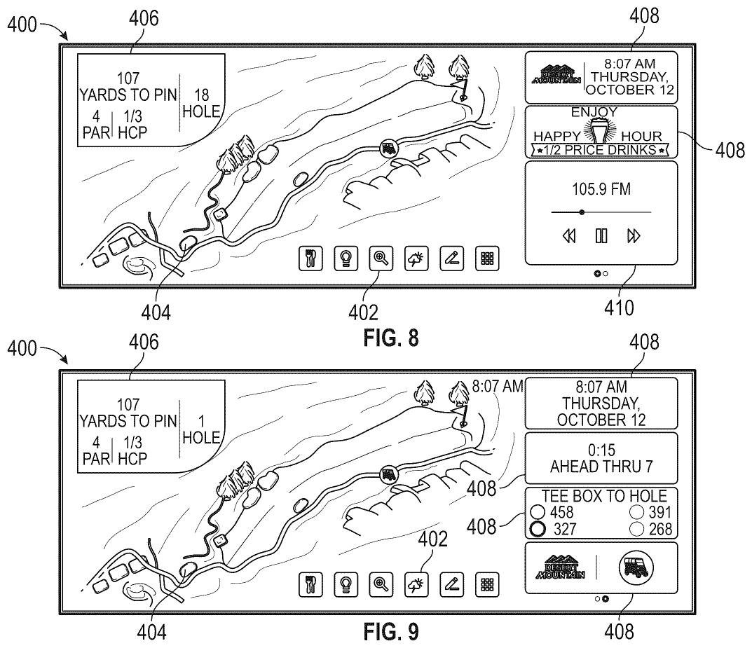

As shown in FIG. 7-12, the hole GUI 400 includes a menu element, shown as menu options 402, a hole element, shown as hole view 404, a hole info element (e.g., a hole information panel), shown as hole info 406, and one or more widgets, as described in greater detail herein. The menu options 402 may include one or more of the select course button 354, the map button 356, the select hole button 358, the scorecard button 360, the end game button 362, the food and beverage button 364, the weather button 366, the music button 368, the language button 370, the setup button 372, and/or still other buttons. In some embodiments, responsive to the menu options 402 receiving an input, the main menu GUI 350 may be displayed instead of the hole GUI 400. As shown in FIG. 7-12, the menu options 402 are positioned along a bottom edge of the hole GUI 400 such that the menu options 402 do not obstruct the hole view 404 (e.g., leaves the hole view 404 substantially unblocked). In some embodiments, the menu options 402 are otherwise positioned about the hole GUI 400 (e.g., along the top, left, or right edges, scattered about the hole GUI 400, etc.) to not obstruct the hole view 404. In some embodiments, the menu options 402 are configurable by the user (e.g., by an owner of the golf course or the vehicle 10) and updated across a fleet of the vehicles 10 according to the offerings of the golf course (e.g., if the golf course does not offer food and beverage, that button may not be accessible) (see, e.g., FIG. 7 vs. FIG. 8-12).

As shown in FIG. 7-12, the hole view 404 includes a map of the hole the vehicle 10 is currently on (or a specific hole of the golf course selected by the user). The map of the hole included in the hole view 404 may display a cart path, a fairway, a green, sand traps, water hazards, out-of-bounds lines, forest areas, a pin location, a tee box, and/or any other features of the hole. In some embodiments, the hole view 404 is configured to display live updates regarding the location of the vehicle 10 on the hole.

As shown in FIGS. 7-12, the hole info 406 displays information relating to the current hole, including yardage to the pin, par value, handicap value, hole number, stroke number, wind speed, temperature, etc. The hole info 406 is positioned near a top left corner of the hole GUI 400 such that the hole info 406 does not obstruct the hole view 404 (e.g., leaves the hole view 404 substantially unblocked). In some embodiments, the hole info 406 is otherwise positioned about the hole GUI 400 to not obstruct the hole view 404.

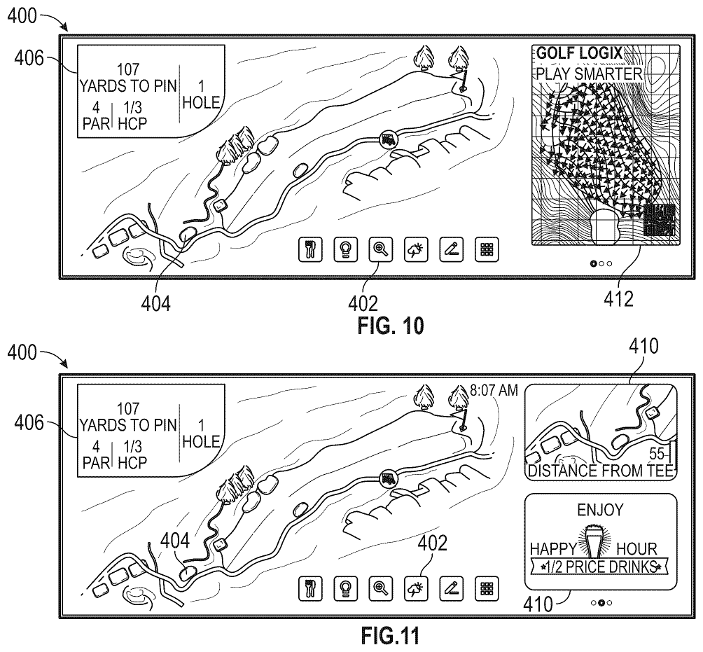

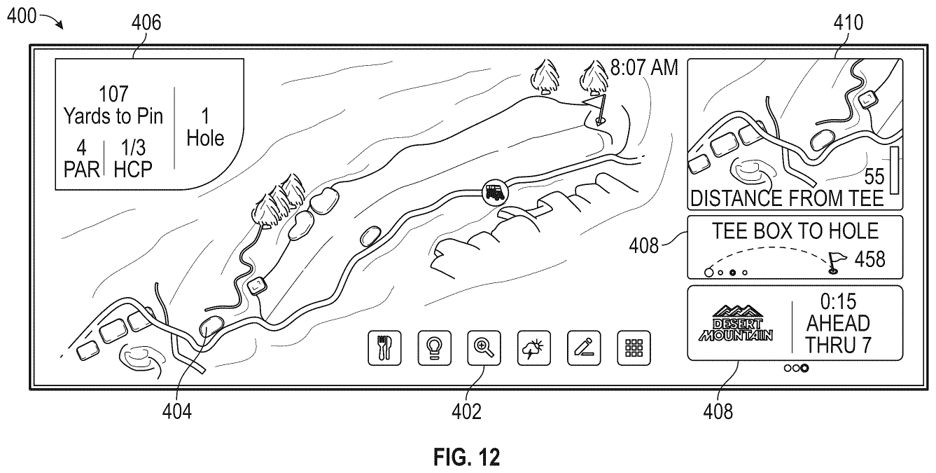

As shown in FIG. 7-12, the one or more widgets (e.g., quarter-sized widgets 408, half-sized widgets 410, full-sized widget 412, etc.) are positioned along a right edge of the hole GUI 400 such that the one or more widgets do not obstruct the hole view 404 (e.g., leaves the hole view 404 substantially unblocked). As shown in FIG. 7, the hole GUI 400 displays a set of widgets including a full-sized widget 412 and a quarter-sized widget 408 positioned therebelow. In some embodiments, the set of widgets displayed by the hole GUI 400 of FIG. 7 are otherwise sized (e.g., a two-thirds-sized widget above or below a one-third-sized widget). In some embodiments, the full-sized widget 412 is positioned below the quarter-sized widget 408. In some embodiments, the positioning of the set of widgets is configurable by the user according to the user's preferences (e.g., using the widget customizer GUI 500). In some embodiments, the set of widgets are displayed in one or more widget panes, such that a first widget pane contains a first subset of widgets, a second widget pane contains a second subset of widgets, and so on. As shown in FIG. 7, the hole GUI 400 includes two widget panes, as indicated by the two circles (e.g., indicators) underneath the quarter-sized widget 408. In some embodiments, the hole GUI 400 includes more or fewer than two widget panes (e.g., one, three, four, etc. panes). By way of example, the user may configure the hole GUI 400 (e.g., using the widget customizer GUI 500) to include a desired number of widget panes (e.g., one widget pane, two widget panes, three widget panes, etc.) with each widget pane having a desired number of widgets. In embodiments where the hole GUI 400 includes two or more widget panes, the user can navigate through the widget panes by swiping (e.g., for touch-screen compatible devices), selecting the circle corresponding to a desired widget pane, using voice commands, using hard keys, buttons, knobs, selectors, etc. of the operator interface 48. The selected circle may provide an indication (e.g., may be highlighted) indicative of selected widget pane being displayed. By way of example, as shown in FIG. 10, the hole GUI 400 includes three circles underneath the full-sized widget 412, indicative of three widget panes, and having the left-most circle highlighted, indicative of the first widget pane being selected and displayed on the hole GUI 400. Similarly, as shown in FIG. 11, the middle circle is highlighted, indicative of the second pane being selected and displayed on the hole GUI 400, and as shown in FIG. 12, the right-most circle is highlighted, indicative of the third widget pane being selected and displayed on the hole GUI 400.

As shown in FIG. 8-12, the hole GUI 400 includes the menu options 402, the hole view 404, the hole info 406, and one or more sets or panes of widgets. Compared to the menu options 402 displayed by the hole GUI 400 in FIG. 7, the menu options 402 displayed in FIG. 8-12 are different and include various other buttons, as described above. As shown in FIG. 8, the set of widgets includes two quarter-sized widgets 408 and a half-sized widget 410. In some embodiments, the set of widgets is configurable to be displayed in any combination (e.g., two quarter-sized widgets 408 then a half-sized widget 410, a quarter-sized widget 408 then a half-sized widget 410 then a quarter-sized widgets 408, a half-sized widget 410 then two quarter-sized widgets 408). As shown in FIG. 9, the set of widgets include four quarter-sized widgets 408. As shown in FIG. 10, the set of widgets includes a full-sized widget 412. As shown in FIG. 11, the set of widgets includes two half-sized widgets 410. As shown in FIG. 12, the set of widgets includes a half-sized widget 410 and two quarter-sized widgets 408. In other embodiments, the set of widgets includes a different combination of widgets than the combinations shown in FIG. 7-12.

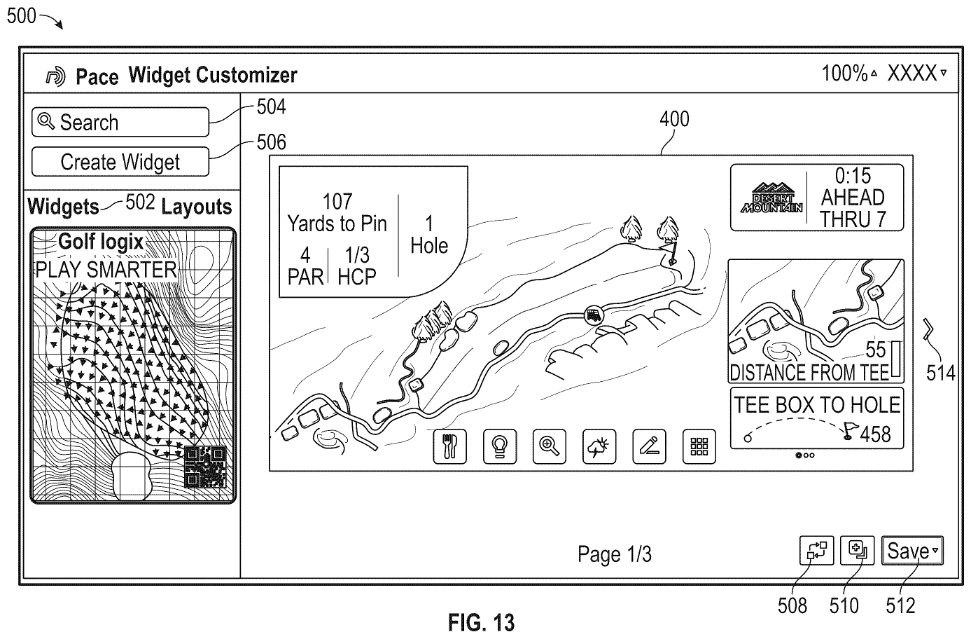

As shown in FIG. 13, a fourth user interface, shown as widget customizer GUI 500, is configured to facilitate configuring (e.g., customizing) the hole GUI 400 (e.g., configuring the number of widgets to be displayed on the hole GUI 400, configuring the number of widget panes to be displayed on the hole GUI 400, configuring the function of each widget displayed on the hole GUI 400, etc.) according to the preferences of the user of the vehicle 10, owner of the vehicle 10, and/or the golf course the vehicle 10 is associated with. The widget customizer GUI 500 can be provided to the operator interface 48 and/or the user device 232 for display on the one or more displays thereof, respectively. As shown in FIG. 13, the widget customizer GUI 500 includes a plurality of widget options, shown as widget list 502, a widget search element, shown as search bar 504, a new widget element, shown as create widget button 506, an element for configuring a location of the widgets and/or an arrangement of the widget panes, shown as arranger tool 508, a new widget pane element, shown as new widget pane button 510, and a save configuration element, shown as save button 512.

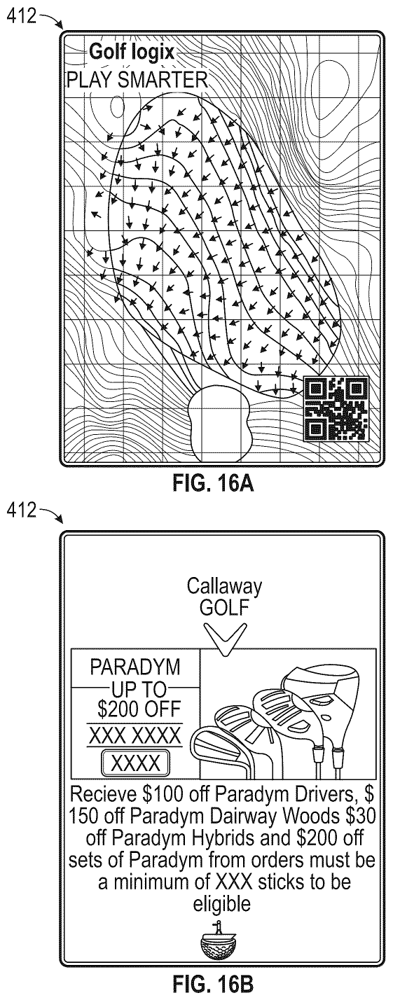

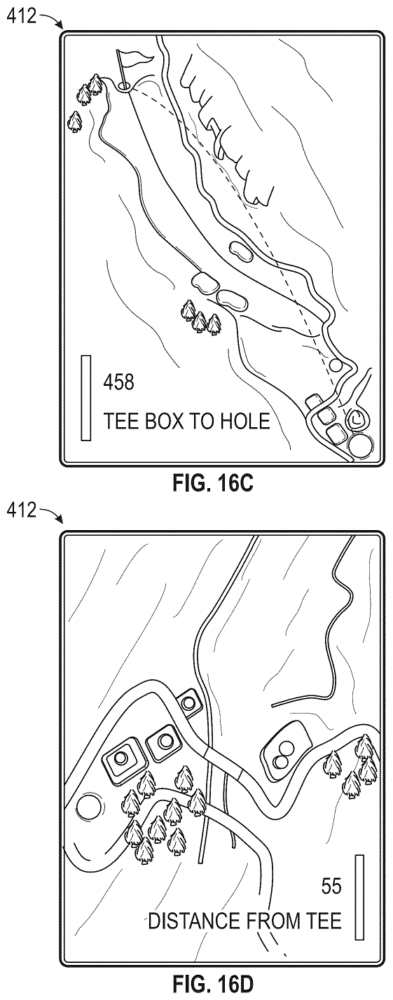

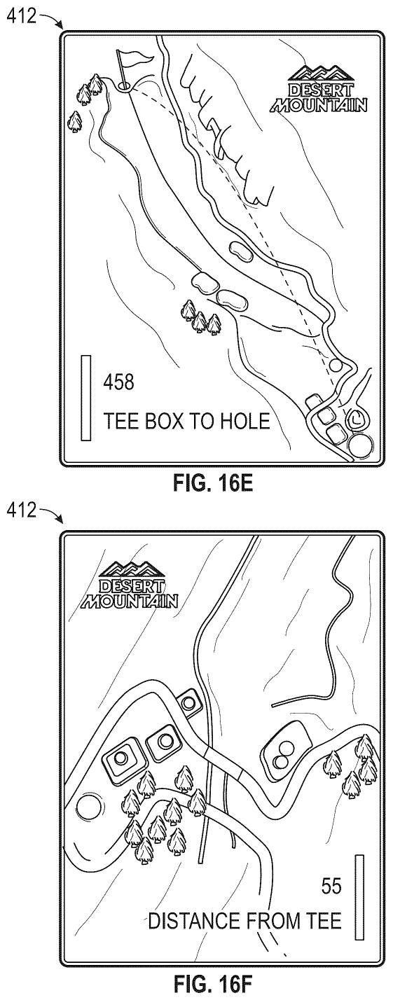

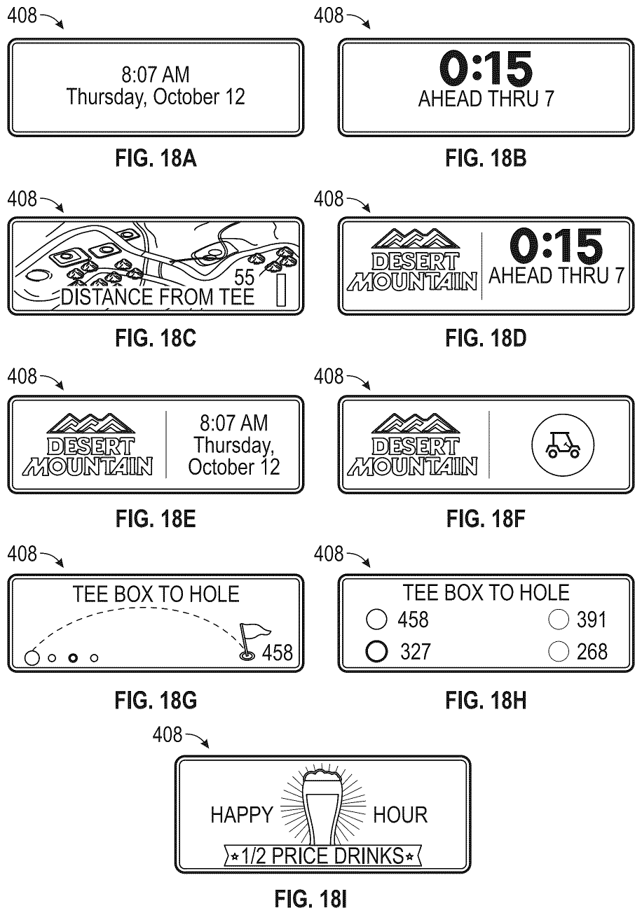

According to an exemplary embodiment, the widget list 502 may be navigable by the user to view the different sizes of widgets and the different functions (e.g., styles, types, etc.) thereof available to be displayed by the hole GUI 400. By way of example, the user may navigate through the widget list 502 to view the quarter-sized widgets 408, the half-sized widgets 410, and the full-sized widgets 412 and the different functions thereof (e.g., the quarter-sized widgets 408 shown in FIG. 18A-18I, the half-sized widgets 410 shown in 17A-17U, and the full-sized widgets 412 shown in FIG. 16A-16F). From the widget list 502 the user may select a particular widget to add the particular widget to be displayed by the hole GUI 400 (e.g., or to replace a particular widget being displayed by the hole GUI 400). By way of example, the user may select a half-sized widget 410 and two quarter-sized widgets 408 to be displayed by the hole GUI 400. In such an example, the user may configured the order of the widgets (as described in greater detail with respect to FIG. 7-12 above) and which widget pane the particular widgets are added to. The search bar 504 may be configured to receive an input from the user to query the database of available widgets to find a particular widget. By way of example, the user may type “TIME” into the search bar 504 to find all widgets relating to date and time. After selecting a desired widget, the user may provide an input to the create widget button 506 to add the desired widget to be displayed by the hole GUI 400. In some embodiments, the create widget button 506 may open a new window (e.g., size pop-up window 600, functionality pop-up window 700, etc.) to provide the user the option to create a widget having a particular size and function. As shown in FIG. 13, the widget customizer GUI 500 displays a preview of the hole GUI 400, such that modifications to the configuration of the hole GUI 400 responsive to the inputs to the widget customizer GUI 500 can be previewed (e.g., in real-time, hole GUI 400 before confirming those modifications to update the hole GUI 400).

According to an exemplary embodiment, responsive to an input to the arranger tool 508, the user may arrange/rearrange, position, orientate, etc. the widget panes and/or the widgets for display by the hole GUI 400. In some embodiments, responsive to an input to the new widget pane button 510, the user may add, delete, re-order, or otherwise customize widget panes for display by the hole GUI 400. For example, after the new widget pan button 510 is selected, the user may select the arranger button 5080 to re-order the widget panes (e.g., move the new widget pane to the front, middle, back, etc.). The arranger tool 508 may provide an option to spatially arrange the widgets relative to each other within a widget pane. For example, two quarter-sized widgets 408 originally above a half-sized widget 410 may be rearranged using the arranger tool 508 such that one quarter-sized widget 408 is moved below the half-sized widget 410 to create a “quarter-half-quarter” arrangement. By way of another example, both quarter-sized widgets 408 may be moved below the half-sized widget 410 to create a “half-quarter-quarter”arrangement. In some embodiments, the arranger tool 508 provides an option for moving one or more widgets to a different widget pane (e.g., two half-sized widgets 410 originally on the first widget pane and the arranger tool 508 facilitates moving at least one half-sized widget 410 to the second widget pane). For example, the arranger tool 508 may be used in combination with a page navigation button 514 to move one or more widgets to a different widget pane. In some embodiments, responsive to an input to the page navigation button 514, the user may navigate through the one or more widget panes to be displayed by the hole GUI 400 or navigate through the saved templates for the hole GUI 400. In some embodiments, other GUI layout options include cropping widgets, deleting widgets, changing an orientation of widgets, downloading pre-made GUI templates or widgets, etc.

According to an exemplary embodiment, the new widget pane button 510 is configured to receive an input to add one or more new widget panes to the hole GUI 400. In some embodiments, responsive to providing an input to the new widget pane button 510, the widget customizer GUI 500 adds a new widget pane to be customized. In some embodiments, responsive to providing an input to the new widget pane button 510, an additional pane indicator may be added to the set of widget pane indicators. For example, if the hole GUI 400 includes two widget panes with two corresponding indicators (e.g., circle, pane number, etc.), responsive to adding a new widget pane (e.g., via the new widget pane button 510), a new corresponding indicator is added such that three indicators will be present. In some embodiments, if the hole GUI 400 includes one widget pane, a widget pane indicator is not displayed. Then, responsive to adding a new widget pane (e.g., via the new widget pane button 510), two corresponding indicators may be displayed.

According to an exemplary embodiment, responsive to an input to the save button 512 the modifications made to the hole GUI 400 are saved (e.g., by the memory 104, the memory 254, and/or the memory 264) as a template for future use. In some embodiments, the save button 512 facilitates storing data to a user profile (e.g., a user logs into a display device on the vehicle 10 and their saved hole GUI 400 is loaded, for example, by an API call to a database, by pre-set startup operations, by internal memory instructions, by a boot loader, etc.). In some embodiments, the save button 512 facilitates temporarily saving the hole GUI 400 for display on the operator interface 48 (e.g., for the length of a round of golf), and then may discard the data. In some embodiments, the save button 512 may facilitate loading prior-saved GUI(s) 400 or pre-set GUI(s) 400 (e.g., making one or more API calls to a database, loading from internal memory, etc.).

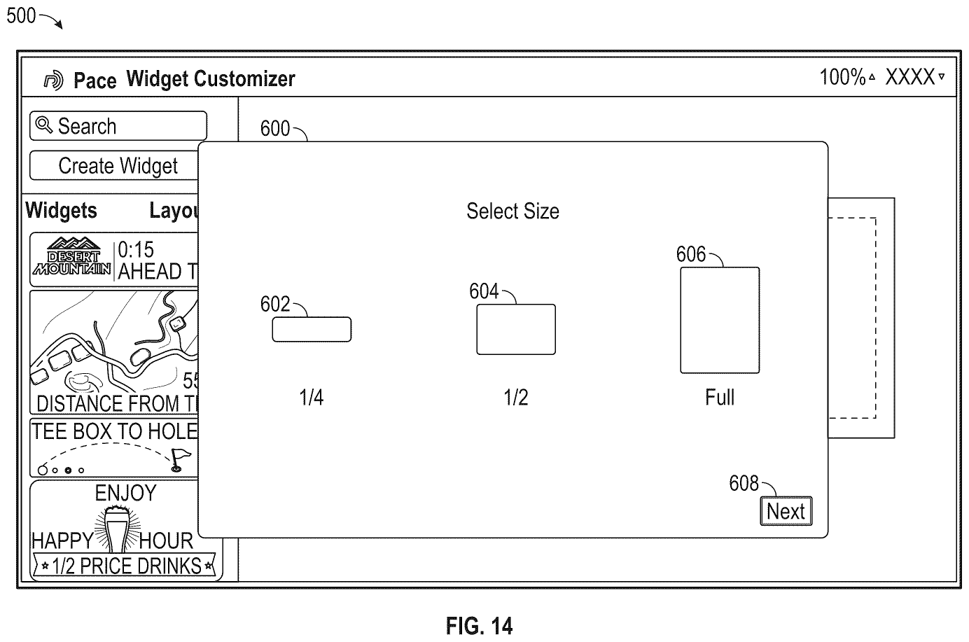

In some embodiments, the widget customizer GUI 500 is configured to transmit updates to the operator interface 48 and/or the user device 232 responsive to an input to the save button 512 or automatically (e.g., each time an edit is made an update is sent, after the passage a predetermined time an update is sent, etc.) to update the configuration of the hole GUI 400. This update may, for example, be transmitted via the communications network 210, locally (e.g., via a LAN), or without the communications network 210 or a local network (e.g., the widget customizer GUI 500 can be displayed on the operator interface 48 and/or the user device 232 such that widget customization occurs on the local machine in real-time, regardless of network integration features). In embodiments where the widget customizer GUI 500 is accessed by a device remote from the vehicle 10 (e.g., the user device 232), updates may be pushed directly to the vehicle 10 over the communications network 210 and/or by the remote systems 240. As shown in FIG. 14, the widget customizer GUI 500 is configured to display a size pop-up window 600 responsive to an input provided to the create widget button 506. The size pop-up window 600 displays various options for selecting the size of a new widget. For example, the size pop-up window 600 may provide various selectors regarding pre-set widget sizes such as a quarter-sized widget selector 602, a half-sized widget selector 604, and/or a full-sized widget selector 606. In some embodiments, the size pop-up window 600 may provide customizable options (e.g., a cropping tool, a size adjustment tool, a size input tool with height and width values, etc.). In some embodiments, the size pop-up window 600 appears partially or wholly over the hole GUI 400 (e.g., over the preview of the hole GUI 400 displayed by the widget customizer GUI 500) and/or the components of the widget customizer GUI 500. In some embodiments, the size pop-up window 600 is a separate GUI.

As shown in FIG. 14, the size pop-up window 600 includes one or more selection options 608. The selection options 608 may facilitate advancing a selection process (e.g., a process of selecting a size and a function of the widget, proceeding to a next or previous step, etc.), provide an option to select which widget pane to put the widget on, provide an option to select multiple sizes in order to generate multiple widgets at once, etc. In some embodiments, providing an input to the selection options 608 advances the selection process to the next step thereof. For example, the selection options 608 may include an advance or next button that when selected causes a new pop-up window, screen, and/or set of options to appear. In some embodiments, the widget customizer GUI 500 may display an error message if a user attempts to advance to the next step, but has not yet selected a size.

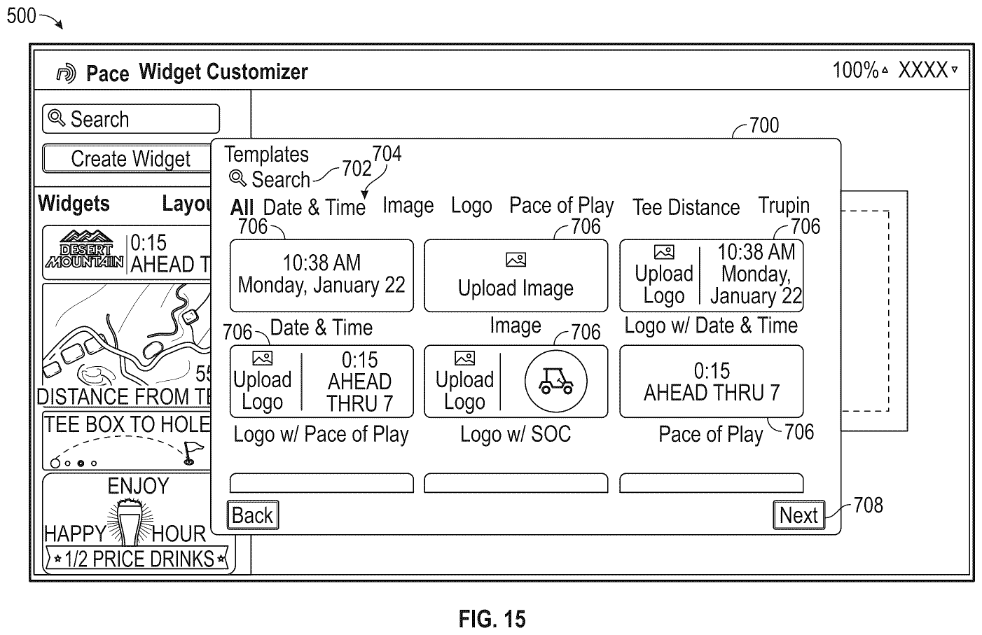

As shown in FIG. 15, the widget customizer GUI 500 is configured to display a functionality pop-up window 700 responsive to an input provided to the create widget button 506. In some embodiments, the widget customizer GUI 500 is configured to display a functionality pop-up window 700 responsive to an input provided to the selection options 608 to advance the selection process. In some embodiments, if only one size widget fits in a widget pane being currently edited, then a size selection process may be skipped (e.g., the widget customizer GUI 500 does not display the size pop-up window 600).

As shown in FIG. 15, the functionality pop-up window 700 includes a widget search element, shown as search bar 702. The search bar 702 may be configured to receive an input from the user to query the database of available widgets to find a particular widget (e.g., a widget with a general function or a specific function). By way of example, the user may type “TIME” into the search bar 702 to find all widgets relating to date and time. By way of another example, the user may desire to create a widget with a music player and a time indicator, in which case a search may include “music and time,”or “music time,”or “music player with time,”etc.

As shown in FIG. 15, the functionality pop-up window 700 includes one or more filters, shown as filter options 704, configured to provide an option to filter the widgets displayed in the functionality pop-up window 700 based on the function of the widget (e.g., to filter the widgets displayed after completing a search query, to filter all of the widgets stored in a widget database, etc.). Selecting a certain filter by providing an input to the filter options 704 removes any widgets being displayed that are not associated with the selected filter and/or adds any widgets not already displayed that are associated with the selected filter. In some embodiments, the filter options 704 facilitate dynamic filtering of the displayed widgets in the functionality pop-up window 700 (e.g., providing an input to a filter causes any displayed widgets not in that category to be removed until the input is no longer provided). In some embodiments, the set of filter options 704 correspond to the functions of the various widgets. For example, the set of filter options 704 (e.g., the function, style, type, etc.) of the widget may include date and time widgets, image widgets, logo widgets, pace of play widgets, yardage widgets, etc. The set of filter options 704 may include more or fewer options than those shown in FIG. 15, and may be updated to add or delete filter options 704.

As shown in FIG. 15, the functionality pop-up window 700 is configured to display one or more widgets, shown as template widgets 706. In some embodiments, the template widgets 706 correspond to the various widgets described below with respect to FIG. 16-18. In some embodiments, the user can upload an image or logo to be displayed by portion of the template widgets 706 (e.g., one half of the widget). In some embodiments, the size of the template widgets 706 corresponds to the size selected in size pop-up window 600. For example, if the quarter-sized widget selector 602 was selected in size pop-up window 600, then the template widgets 706 will include widgets that are quarter-sized (e.g., and not include template widgets 706 that are half-sized or full-sized).

As shown in FIG. 15, the functionality pop-up window 700 includes one or more selection options 708. The selection options 708 may facilitate advancing a selection process (e.g., a process of selecting a size and a function of the widget, proceeding to a next or previous step, etc.), provide an option to select which widget pane to put the widget on, provide an option to select multiple sizes in order to generate multiple widgets at once, etc. In some embodiments, providing an input to the selection options 708 advances the selection process to the next step thereof. For example, the selection options 708 may include an advance or next button that, when selected, causes a new pop-up window, screen, and/or set of options to appear and a return or back button that, when selected, returns to a previous screen of the widget customizer GUI 500 (e.g., returns to the size pop-up window 600). In some embodiments, when the advance button is selected, the process of selecting a size and a function of the widget may end, and the functionality pop-up window 700 terminates. In some embodiments, the widget customizer GUI 500 may display an error message if a user attempts to move to the next step in creating a widget, but has not yet selected a function of the widget.

As shown in FIG. 16A-16F, different functions of the full-sized widget 412 are configured to display different types of information relating to a golf course on which the vehicle 10 is operating, information relating to operation of the vehicle 10, and/or any other information. As shown in FIG. 16A, the full-sized widget 412 displays a topographical map of the green (e.g., a green for the hole being played by the golfer). In some embodiments, the full-sized widget 412 displays a topographical map of the fairway, a sand trap, the rough, etc. As shown in FIG. 16B, the full-sized widget 412 displays an advertisement, for example, an advertisement for golfing equipment such as a driver, an advertisement for food and drink specials at the clubhouse, etc. As shown in FIGS. 16C and 16D, the full-sized widget 412 displays a distance to the pin from the tee box and a distance to the tee box from the current location of the golfer. In some embodiments, the full-sized widget 412 is configured to display a distance from the current location of the vehicle 10 to the pin, a total yardage of the hole, a distance from a geographic point on the golf course (e.g., selected by the user via an input to the hole GUI 400) to the pin, etc. As shown in FIGS. 16E and 16F, the full-sized widget 412 can be customized to display an image, such as a logo or brand. In some embodiments, the full-sized widget 412 displays other information such as animations of tracked golf shots and swing paths, animations of a shot the golfer would need in order to reach the pin, including factors such as swing speed, club head angle, wind speed, green topography, etc.

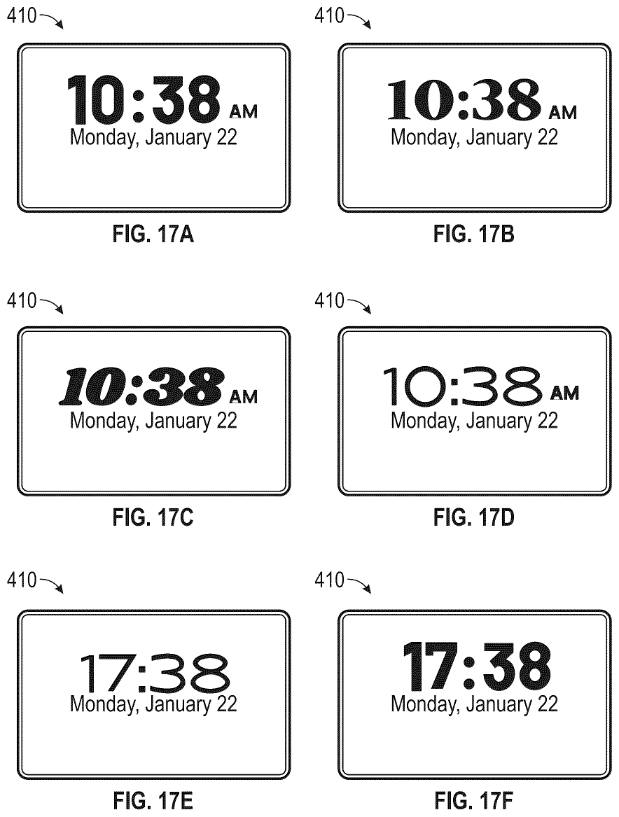

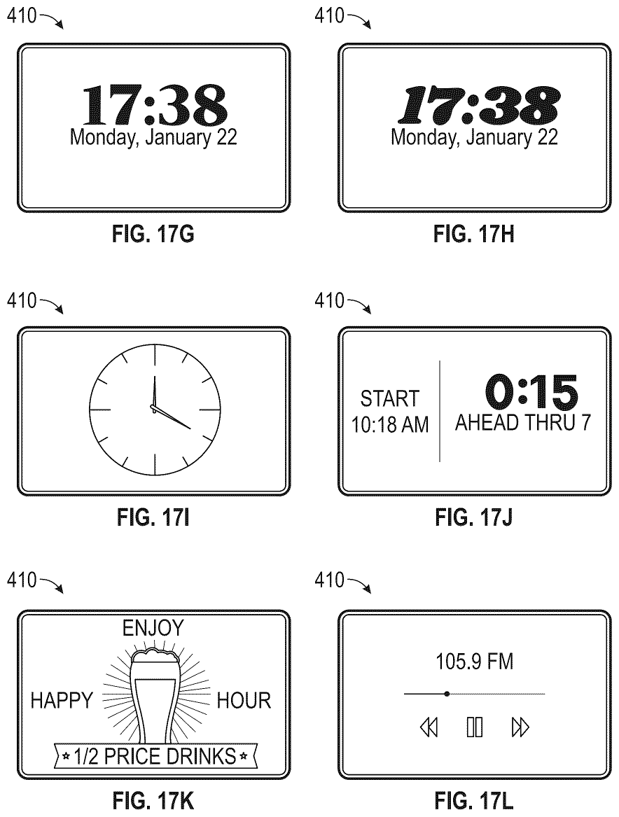

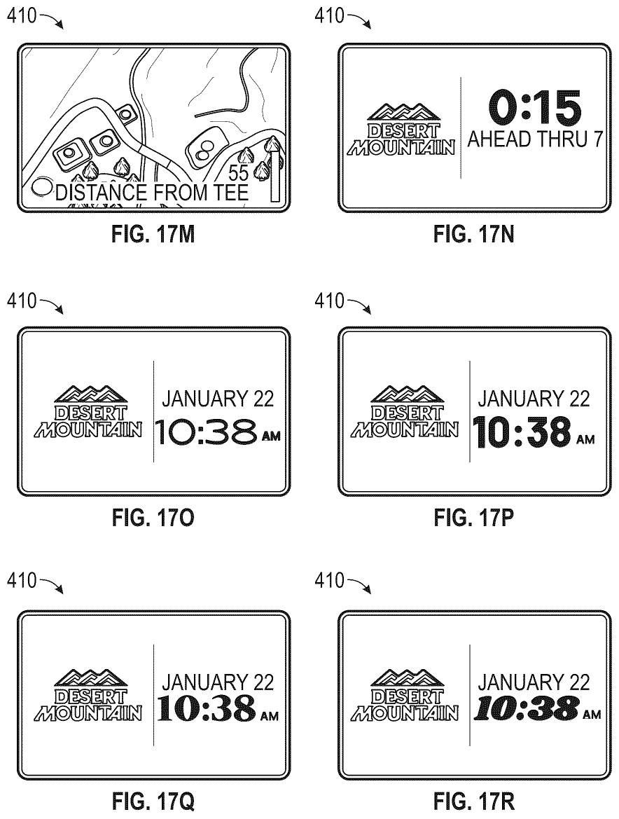

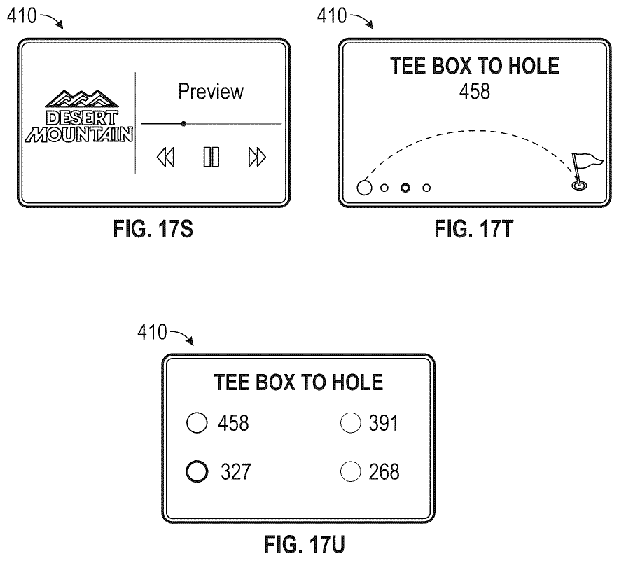

As shown in FIG. 17A-17U, different functions of the half-sized widget 410 are configured to display different types of information relating to a golf course on which the vehicle 10 is operating, information relating to operation of the vehicle 10, and/or any other information. As shown in FIG. 17A-17J, the half-sized widgets 410 are configured to display the date, including the day, month, year, time, etc. The half-sized widgets 410 are configurable to display the date and time in various font sizes, styles, and modifiers (e.g., bold, italic, underline, etc.). The time of day may be displayed in a 12-hour time format, including the indicators “A. M. ” and “P. M. ” for morning and afternoon, respectively (see, e.g., FIG. 17A-17D), or the time of day may be displayed in a 24-hour time format (see, e.g., FIG. 17E-17H). Furthermore, the time of day may be displayed on a digital clock (see, e.g., FIG. 17A-17H) or on an analog clock (see, e.g., FIG. 17I). As shown in FIG. 17J, the half-sized widget 410 may additionally display other information with the time, such as round start time, a golfer who is in the lead, time spent on course, time spent on individual hole, etc. As shown in FIG. 17K, the half-sized widget 410 displays advertisements. As shown in FIGS. 17M, 17T, and 17U, the half-sized widget 410 is configured to display relevant information to the current golfer, such as distance from tee to the hole, distance from current shot to the hole, or other information relating to the golfer and the location thereof. As shown in FIG. 17L, the half-sized widgets 410 display and perform functions unrelated to the sport of golf, such as an audio player (e.g., a music player, a radio, an audiobook player, etc.), a weather radar, email integration, etc. The half-sized widget 410 may be paired with an image, such as a logo or brand (see, e.g., FIG. 17N-17S). The half-sized widget 410 may be paired in combination with one another to have multiple functions present in the same half-sized widget 410 (see, e.g., FIG. 17N-S).

As shown in FIG. 18A-18I, different functions of the quarter-sized widget 408 are configured to display different types of information relating to a golf course on which the vehicle 10 is operating, information relating to operation of the vehicle 10, and/or any other information. As shown in FIGS. 18A and 18B, the quarter-sized widgets 408 are configured to display the date, including the day, month, year, time, etc., as described in greater detail above with respect to the half-sized widgets 410. As shown in FIG. 18I, the quarter-sized widget 408 displays advertisements. As shown in FIGS. 18C, 18G, and 18H, the quarter-sized widget 408 is configured to display relevant information to the current golfer, such as distance from tee to the hole, distance from current shot to the hole, or other information relating to the golfer and the location thereof. In some embodiments, the quarter-sized widgets 408 display and perform functions unrelated to the sport of golf, such as an audio player (e.g., a music player, a radio, an audiobook player, etc.), a weather radar, email integration, etc. The quarter-sized widget 408 may be paired with an image, such as a logo or brand (see, e.g., FIG. 18D-18F). The quarter-sized widget 408 may be paired in combination with one another to have multiple functions present in the same half-sized widget 410 (see, e.g., FIG. 18D-18F).

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf system for customizing a graphical user interface, the golf system comprising:
a golf vehicle including a display device and a first communications interface; and
a server including:
a second communications interface configured to facilitate communications with the first communications interface and a user device; and
one or more processing circuits configured to:
provide a first graphical user interface on the user device, the first graphical user interface including a widget customizer that facilitates selecting one or more widgets of a second graphical user interface for display on the display device;
receive inputs from the user device through the widget customizer to select the one or more widgets of the second graphical user interface, the inputs including a first selection of a size of the one or more widgets and a second selection of a function of the one or more widgets; and
transmit data corresponding to the second graphical user interface to the first communications interface of the golf vehicle;
wherein the display device is configured to display the second graphical user interface in accordance with the data.

2. The golf system of claim 1, wherein the second graphical user interface includes:
a widget pane including the one or more widgets;
a hole view displaying a map corresponding to a golf hole on which the golf vehicle is located;
one or more menu options corresponding to one or more functions of the golf system; and
a hole information panel displaying information corresponding to the golf hole.

3. The golf system of claim 2, wherein the widget pane includes a plurality of panes, and wherein the second graphical user interface includes a widget pane indicator below the plurality of panes, wherein the widget pane indicator displays an indicator regarding a displayed widget pane of the plurality of panes.

4. The golf system of claim 3, wherein the plurality of panes can be navigated through via user input, and wherein the widget pane indicated updates as the plurality of panes are navigated through.

5. The golf system of claim 4, wherein navigating through the plurality of panes does not cause the hole view, the one or more menu options, and the hole information panel to change.

6. The golf system of claim 2, wherein the hole view is located to the left of the widget pane, the one or more menu options are located below the hole view, and the hole information panel is located to the left of the hole view.

7. The golf system of claim 2, wherein the information corresponding to the golf hole includes at least one of:
a hole number for the golf hole;
a par value for the golf hole;
a handicap value for the golf hole; or
a distance from the golf vehicle to a pin of the golf hole.

8. The golf system of claim 7, wherein the information corresponding to the golf hole includes:
the hole number for the golf hole;
the par value for the golf hole;
the handicap value for the golf hole; and
the distance from the golf vehicle to the pin of the golf hole.

9. The golf system of claim 2, wherein one or more components of the second graphical user interface is updated as the golf vehicle moves.

10. The golf system of claim 2, wherein the size of the one or more widgets is proportional to the widget pane, the size of the one or more widgets comprising:
a full-sized widget that fills the widget pane;
a half-sized widget that is one half of a height of the full-sized widget; and
a quarter-sized widget that is one quarter of the height of the full-sized widget.

11. The golf system of claim 1, wherein the widget customizer includes a tool to arrange a position of a first widget of the one or more widgets relative to a second widget within a widget pane.

12. The golf system of claim 1, wherein the function of the one or more widgets includes two or more of:
a topographical map corresponding to a green of a respective hole the golf vehicle is on;
an advertisement;
a first distance indicator corresponding to a first distance for the respective hole;
a second distance indicator corresponding to a second distance from a location of the golf vehicle to a pin for the respective hole;
a date and time indicator;
a music player; or
an image customizable by a user.

13. The golf system of claim 1, wherein the first selection of the size of the one or more widgets is facilitated by a first pop-up window on top of the first graphical user interface including a plurality of sizing options and a first button to advance to the second selection.

14. The golf system of claim 13, wherein the second selection of the function of the one or more widgets is facilitated by a second pop-up window on top of the first graphical user interface provided in response to selection of the first button, the second pop-up window including a plurality of widget templates corresponding to the function of the one or more widgets.

15. A golf system for customizing a graphical user interface, the golf system comprising:
one or more processing circuits comprising one or more memory devices coupled to one or more processors, the one or more memory devices configured to store instructions thereon that, when executed by the one or more processors, cause the one or more processors to:
provide a first graphical user interface on a user device, the first graphical user interface including a widget customizer that facilitates selecting one or more widgets of a second graphical user interface for display on a display device;
receive inputs from the user device through the widget customizer to select the one or more widgets of the second graphical user interface, the inputs including a first selection of a size of the one or more widgets and a second selection of a function of the one or more widgets; and
transmit data corresponding to the second graphical user interface to a communications interface of a golf vehicle;
wherein the display device is configured to display the second graphical user interface in accordance with the data.

16. The golf system of claim 15, wherein the instructions cause the one or more processors to launch a first pop-up window on top of the first graphical user interface, wherein the first pop-up window includes a plurality of sizing options for the first selection and a first button to advance to the second selection.

17. The golf system of claim 16, wherein an interaction with the first button causes the one or more processors to launch a second pop-up window on top of the first graphical user interface, wherein the second pop-up window includes a plurality of widget templates corresponding to the function of the one or more widgets for the second selection.

18. A golf system for customizing a graphical user interface, the golf system comprising:
a non-transitory computer-readable medium having instructions stored thereon that, when executed by one or more processors, cause the one or more processors to:
provide a first graphical user interface on a user device, the first graphical user interface including a widget customizer that facilitates selecting one or more widgets of a second graphical user interface for display on a display device;
receive inputs from the user device through the widget customizer to select the one or more widgets of the second graphical user interface, the inputs including a first selection of a size of the one or more widgets and a second selection of a function of the one or more widgets; and
transmit data corresponding to the second graphical user interface to a communications interface of a golf vehicle;
wherein the display device is configured to display the second graphical user interface in accordance with the data.

19. The golf system of claim 18, wherein the instructions cause the one or more processors to launch a first pop-up window on top of the first graphical user interface, wherein the first pop-up window includes a plurality of sizing options for the first selection and a first button to advance to the second selection.

20. The golf system of claim 19, wherein an interaction with the first button causes the one or more processors to launch a second pop-up window on top of the first graphical user interface, wherein the second pop-up window includes a plurality of widget templates corresponding to the function of the one or more widgets for the second selection.
